(19) United States
(12) Patent Application Publication
(10) Pub. No.: US 2017/0049073 A1
(43) Pub. Date: Feb. 23, 2017

(54) ANIMAL SHELTER AND FOOD TROUGH SYSTEM

(71) Applicant: Andrew Barron, Ruthton, MN (US)

(72) Inventor: Andrew Barron, Ruthton, MN (US)

(21) Appl. No.: 14/829,351

(22) Filed: Aug. 18, 2015

(51) Int. Cl. A01K 5/01

(52) U.S. Cl. CPC A01K 5/01

(57) ABSTRACT

An animal shelter and food trough system houses animals in a shelter which can be opened for ventilation while also preventing buildup of feed and debris within the shelter. The system includes a structure having a roof and an open lateral side extending down from an edge of the roof. A trough is positioned to extend along the open lateral side laterally offset outside of the edge of the roof. A panel has an upper edge coupled to the structure. The panel is pivotable between an open position and a closed position. A lower edge of the panel extends to a position adjacent to or beyond a distal side of the trough relative to the structure when the panel is in the closed position.

### BACKGROUND OF THE DISCLOSURE

Field of the Disclosure

The disclosure relates to shelter and feeding systems and more particularly pertains to a new shelter and feeding system for housing animals in a shelter which can be opened for ventilation while also preventing buildup of feed and debris within the shelter.

Summary of the Disclosure

An embodiment of the disclosure meets the needs presented above by generally comprising a structure having a roof and an open lateral side extending down from an edge of the roof. A trough is positioned to extend along the open lateral side laterally offset outside of the edge of the roof. A panel has an upper edge coupled to the structure. The panel is pivotable between an open position and a closed position. A lower edge of the panel extends to a position adjacent to or beyond a distal side of the trough relative to the structure when the panel is in the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of an animal shelter and food trough system according to an embodiment of the disclosure.

FIG. 2 is a top front side perspective view of an embodiment of the disclosure.

FIG. 3 is a top front side perspective view of an embodiment of the disclosure in a dumping position.

FIG. 4 is a top front side perspective view of an embodiment of the disclosure in a closed position.

FIG. 5 is a side view of a trough support of an embodiment of the disclosure.

FIG. 6 is a side view of an interior cover of an embodiment of the disclosure.

FIG. 7 is a front view of an interior divider of an embodiment of the disclosure.

FIG. 8 is a side view of an interior cover of an embodiment of the disclosure.

### DESCRIPTION OF THE PREFERRED EMBODIMENT

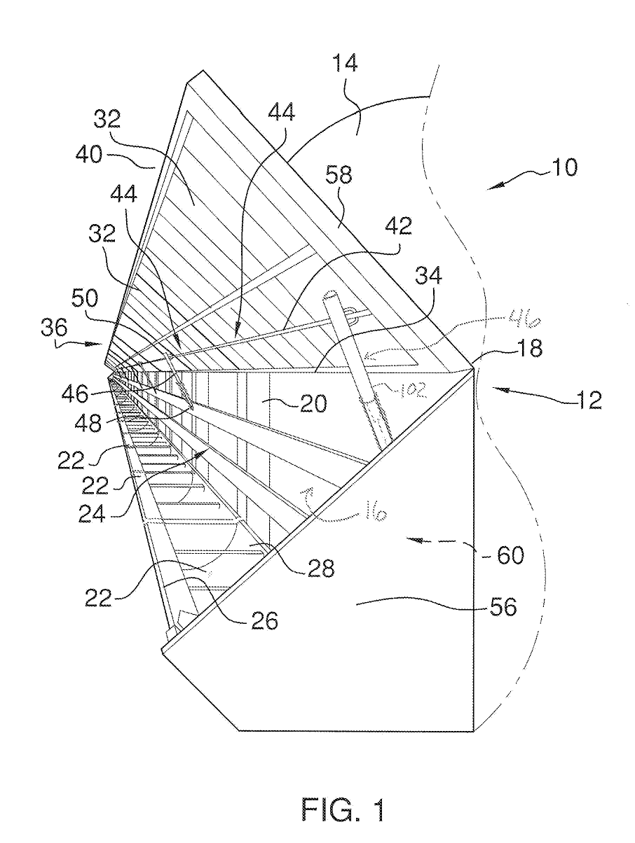

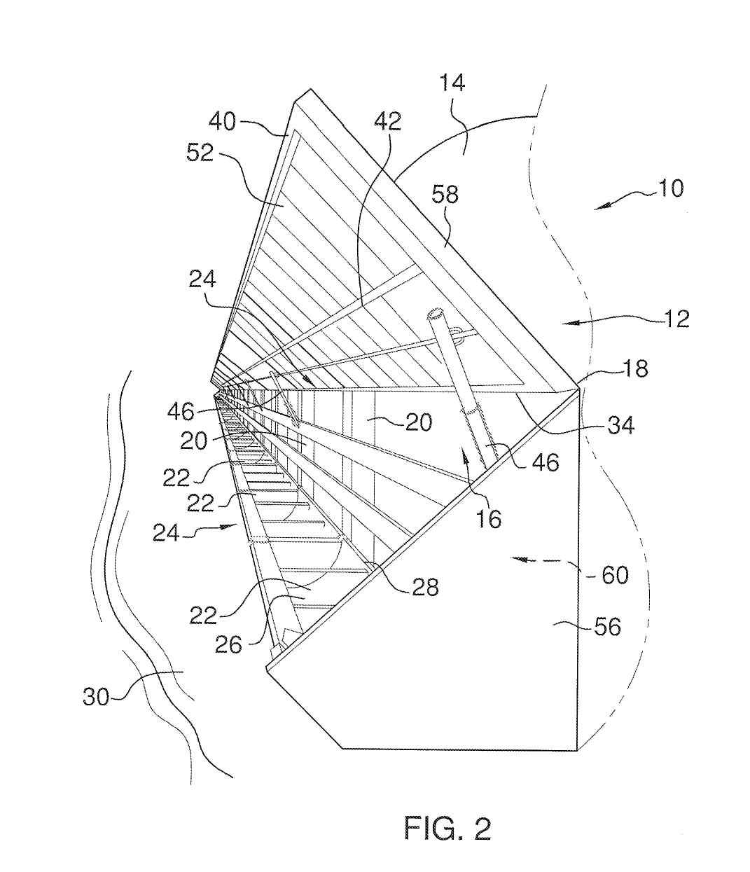

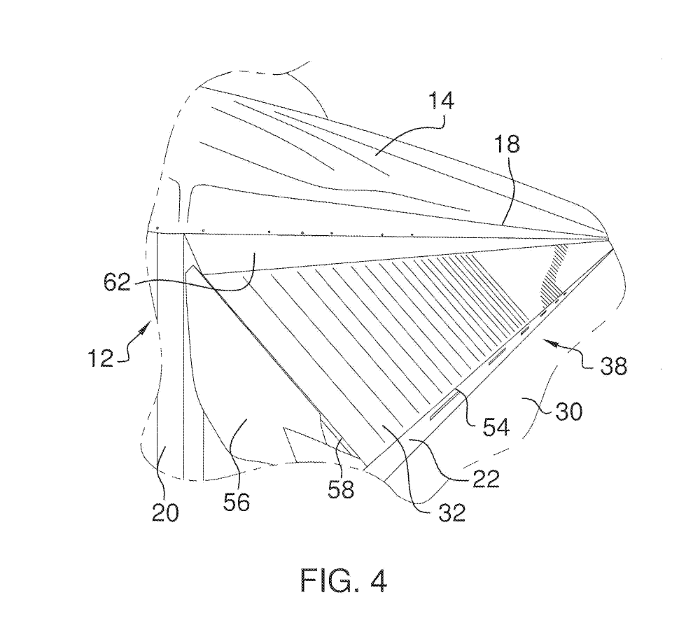

With reference now to the drawings, and in particular to FIGS. 1 through 8 thereof, a new shelter and feeding system embodying the principles and concepts of an embodiment of the disclosure and generally designated by the reference numeral 10 will be described.

As best illustrated in FIGS. 1 through 8, the animal shelter and food trough system 10 generally comprises a structure 12 having a roof 14 and an open lateral side 16 extending down from an edge 18 of the roof 14. The edge 18 of the roof 14 may extend further outwardly from the open lateral side 16 provided any overhang does not interfere with operation and function of the system 10 as herein described. The structure 12 includes a plurality of spaced uprights 20 positioned along the open lateral side 16. It is also further contemplated that the system 10 is herein described having one open lateral side 16 but the structure described below may be equally applied to each outer side of a building structure.

Each of a plurality of troughs 22 is longitudinally aligned along the open lateral side 16. Each trough 22 is positioned outside of the spaced uprights 20 relative to the structure 12 and may be laterally offset outside of the edge 18 of the roof 14 relative to the structure 12. Each trough 22 is aligned with a respective gap 24 between the spaced uprights 20. Each trough 22 is pivotable about a distal side 26 of the trough 22 relative to the structure 12 such that a proximal side 28 of the trough 22 relative to the structure 12 moves upwardly and away from the structure 12. Thus, the trough 22 pivots outwardly from the structure 12 such that the trough 22 is configured for being emptied and depositing contents of the trough 22 onto a ground surface 30 outside of the structure 12. As the troughs 22 are aligned, dumping of all the troughs 22 results in a line of dumped material outside the structure 12 facilitating cleanup, collection, or other use of the dumped material.

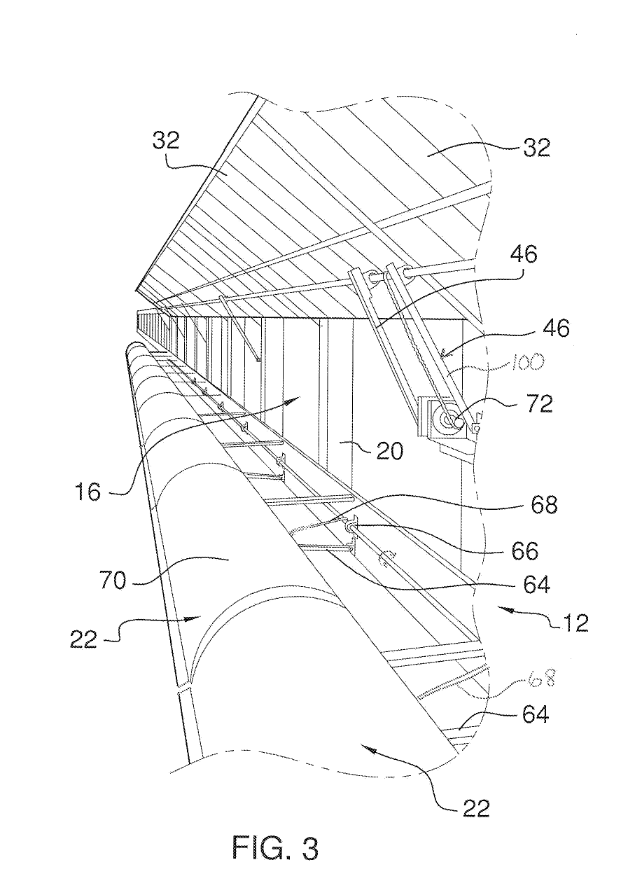

In an embodiment, each of a plurality of panels 32 is positioned in alignment with an associated one of the troughs 22. Each panel 32 has an upper edge 34 coupled to the structure 12. Each panel 32 is pivotable between an open position 36 and a closed position 38. A lower edge 40 of each panel 32 abuts the distal side 26 of the associated one of the troughs 22 relative to the structure 12 when the panel 32 is in the closed position 38. Thus, the panel 32 covers the associated trough 22 while the associated trough 22 remains accessible from inside the structure 12. A bar 42 is coupled to and extends across each of the panels 32. The bar 42 may be unitary such that all of the panels 32 move together when the bar 42 is moved. Alternatively, the bar 42 may have a plurality of sections 44. Each section 44 corresponds to an associated one of the panels 32 wherein each of the panels 32 is separately pivotable to move independently. A conventional mechanism may be applied to join the sections 44 allowing the sections 44 to move together as a single piece. Each of a plurality of rams 46 has a first end 48 coupled to the structure 12 and a second end 50 coupled to the bar 42 such that extension of the rams 46 pivots the panels 32 into the open position 36. The rams 46 may be powered by a motor 72 or manual with conventional construction to assist in smooth pivoting of the panels 32. Each ram 46, for purposes of this disclosure, may be a solid rod 100, as shown in FIG. 3, which pivots the panel 32. Alternatively, the ram 46 may be an telescopic arm 102 as shown in FIG. 1 wherein expansion and contraction of the arm 102 pivots the panel 32. Each section 44 of the bar 42 has at least one ram 46 coupled thereto when the bar 42 does have the sections 44 as described above.

A lip 54 extends from the lower edge 40 of each panel 32 relative to the structure 12. The lip 54 extends over the distal side 26 of the trough 22 when the panel 32 is in the closed position 38. Each of a pair of end pieces 56 is coupled to a free edge 58 of an outermost one of the panels 32. Each end piece 56 extends between the structure 12, the outermost one of the panels 32, and the associated trough 22 wherein each end piece 56 covers a respective end opening 60 between the panels 32 and the structure 12 when the panels are in the closed position 38. Thus, the panel 32 and end pieces 56 enclose the open lateral side 16 when the panel 32 is in the closed position 38. A flap 62 may be coupled to the structure 12 extending over the upper edge 34 of the panel 32.

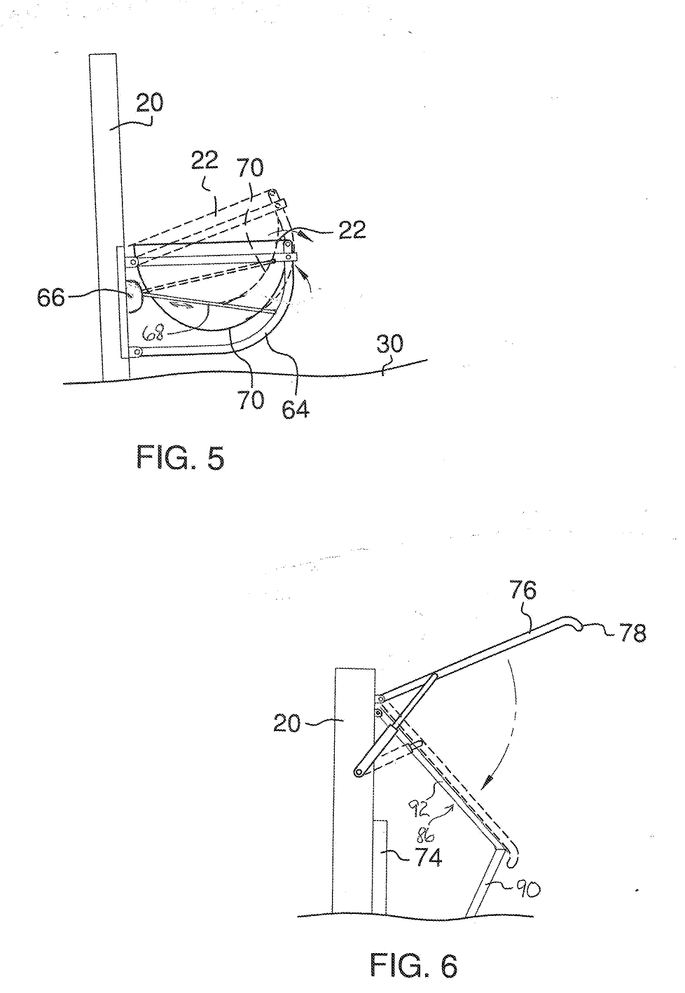

Shown in FIGS. 3 and 5, each trough 22 is supported on a respective pair of arms 64 pivotally coupled to the structure 12. A winch 66 is coupled to the structure 12 and to each arm 64 by a respective fine 68. Retraction of the line 68 lifts the arms 64 tilting the troughs 22 towards the structure 12. A bottom 70 of each trough 22 is curved along a longitudinal axis such that tilting of the trough 22 towards the structure 12 produces a shallower capacity for the trough 22 to hold feed. Thus, the troughs 22 are adjustable to hold a selectable amount of feed corresponding to differing needs of different animals kept within the structure 12.

In an embodiment, a single panel 52 may be employed in place of the panels 32. Additionally, the separate panels 32 may have a mechanism for coupling adjacent panels 32 together to act together.

In use, animals can be housed in the structure 12 and fed using the troughs 22. As needed, the troughs 22 can be emptied and cleaned by pivoting the troughs 22 and then clearing the dumped material in whatever manner desired. The panel 32 can be lifted to provide airflow into the structure 12 when desired and closed to substantially seal the structure 12 from the elements when desired.

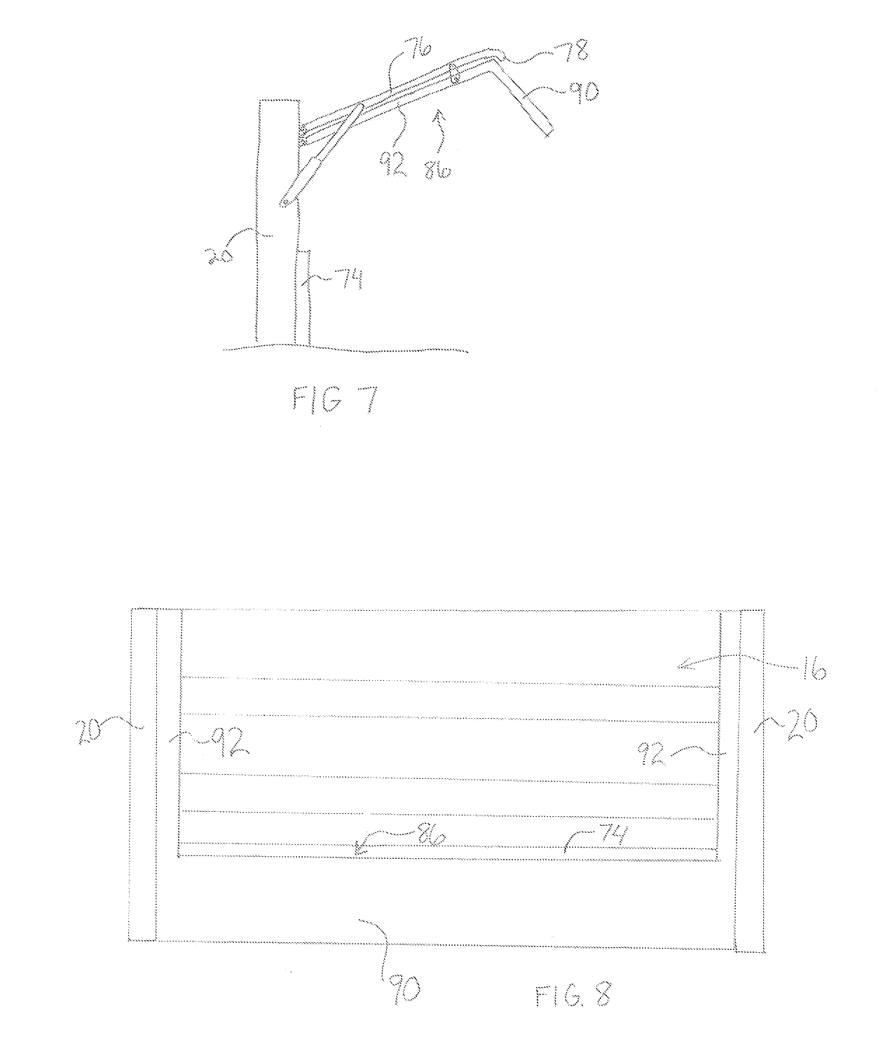

As shown in FIGS. 6 through 8, an alternative embodiment to the troughs 22 is presented for use with the structure 12 and uprights 20. The alternative embodiment provides for formation of a temporary defined area to hold feed instead of in the troughs 22. This may be employed in situations where different amounts of feed are typically used such that the configuration of the alternative embodiment is more desirable. A cover 76 is pivotally attached to the structure 12 using the uprights 20. A distal end 84 of the cover 76 has a hook 78 to extend over an interior divider 86. The interior divider 86 has a bottom section 90 which facilitates retention of feed and debris between the bottom section 90 and a curb 74 extending along the open lateral side 16 and between the uprights 20. The interior divider 86 has a plurality of spaced upper sections 92 defining a window 96 with the bottom section 90 allowing access to the feed between the curb 74 and the bottom section 90 while the interior divider 86 is lowered. The interior divider 86 may be coupled to the cover 76, using a conventional connector, such that the interior divider 86 is elevated with the cover 76 as shown in FIG. 7. This allows free access to the ground area adjacent to the curb 74 to facilitate cleaning when desired. The cover 76 may also be closed to close the open lateral side 16 of the structure 12. This alternative embodiment can employ the structure of the earlier described embodiment shown in FIGS. 1 through 5 except where mutually exclusive. Specifically, rams and end pieces may be employed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal shelter and food trough system comprising:
a structure having a roof and an open lateral side extending down from an edge of said roof;
a trough positioned to extend along said open lateral side laterally offset outside of said edge of said roof; and
a panel having an upper edge coupled to said structure, said panel being pivotable between an open position and a closed position, a lower edge of said panel being positioned to extend beyond a distal side of said trough relative to said structure when said panel is in said closed position.

2. The system of claim 1, further comprising said trough being pivotable about said distal side of said trough outwardly from said structure wherein said trough is configured for being emptied and depositing contents of said trough onto a ground surface outside of said structure.

3. The system of claim 1, further comprising said trough being one of a plurality of troughs extending along said open lateral side of said structure.

4. The system of claim 3, further comprising said panel being coextensive with said plurality of troughs.

5. The system of claim 3, further comprising said panel being one of a plurality of panels, each of said panels being positioned in alignment with an associated one of said troughs.

6. The system of claim 5, further comprising:
a bar coupled to and extending across each of said panels; and
a plurality of rams, each of said rams having a first end coupled to said structure, each of said rams having a second end coupled to said bar such that extension of said rams pivots said panels into said open position.

7. The system of claim 4, further comprising:
a bar coupled to and extending across said panel; and
a plurality of rams, each of said rams having a first end coupled to said structure, each of said rams having a second end coupled to said bar such that extension of said rams pivots said panel into said open position.

8. The system of claim 1, further comprising a lip extending from said lower edge of said panel relative to said structure, said lip extending over said distal side of said trough when said panel is in said closed position.

9. The system of claim 5, further comprising a pair of end pieces, each end piece being coupled to a free edge of an outermost one of said panels, each said end piece extending between said structure, said outermost one of said panels, and said trough wherein each said end piece covers a respective end opening between said panels and said structure when said panels are in said closed position.

10. The system of claim 4, further comprising a pair of end pieces, each end piece being coupled to a free edge of said panel, each said end piece extending between said structure, said panel, and said trough wherein each said end piece covers a respective end opening between said panel and said structure when said panel is in said closed position.

11. The system of claim 1, further comprising a flap coupled to said structure, said flap extending over said upper edge of said panel.

12. The system of claim 3, further comprising said structure including a plurality of spaced uprights positioned along said open lateral side.

13. The system of claim 12, further comprising each said trough being aligned with a respective gap between said spaced uprights.

14. An animal shelter and food trough system comprising:
a structure having a roof and an open lateral side extending down from an edge of said roof, said structure including a plurality of spaced uprights positioned along said open lateral side;
a plurality of troughs longitudinally aligned along said open lateral side, each said trough being positioned laterally offset outside of said edge of said roof relative to said structure, each said trough being aligned with a respective gap between said spaced uprights, each said trough being pivotable about said distal side of said trough outwardly from said structure wherein said trough is configured for being emptied and depositing contents of said trough onto a ground surface outside of said structure;
a panel having an upper edge coupled to said structure, said panel being coextensive with said plurality of troughs, said panel being pivotable between an open position and a closed position, a lower edge of said panel abutting said distal side of said trough relative to said structure when said panel is in said closed position.
a bar coupled to and extending across said panel;
a plurality of rams, each of said rams having a first end coupled to said structure, each of said rams having a second end coupled to said bar such that extension of said rams pivots said panel into said open position;
a lip extending from said lower edge of said panel relative to said structure, said lip extending over said distal side of each said trough when said panel is in said closed position;
a pair of end pieces, each end piece being coupled to a free edge of said panel, each said end piece extending between said structure, said panel, and said trough wherein each said end piece covers a respective end opening between said panel and said structure when said panel is in said closed position; and
a flap coupled to said structure, said flap extending over said upper edge of said panel.

15. An animal shelter and food trough system comprising:
a structure having a roof and an open lateral side extending down from an edge of said roof, said structure including a plurality of spaced uprights positioned along said open lateral side;
a plurality of troughs longitudinally aligned along said open lateral side, each said trough being positioned laterally offset outside of said edge of said roof relative to said structure, each said trough being aligned with a respective gap between said spaced uprights, each said trough being pivotable about a distal side of said trough relative to said structure such that said trough pivots outwardly from said structure wherein said trough is configured for being emptied and depositing contents of said trough onto a ground surface outside of said structure;
a plurality of panels, each of said panels being positioned in alignment with an associated one of said troughs, each said panel having an upper edge coupled to said structure, each said panel being pivotable between an open position and a closed position, a lower edge of each said panel abutting said distal side of said associated one of said troughs relative to said structure when said panel is in said closed position;
a bar coupled to and extending across each of said panels, said bar having a plurality of sections, each section corresponding to an associated one of said panels wherein each of said panels is separately pivotable;
a plurality of rams, each of said rams having a first end coupled to said structure, each of said rams having a second end coupled to said bar such that extension of said rams pivots said panels into said open position, each said section of said bar having at least one ram coupled thereto;
a lip extending from said lower edge of said panel relative to said structure, said lip extending over said distal side of said trough when said panel is in said closed position:
a pair of end pieces, each end piece being coupled to a free edge of an outermost one of said panels, each said end piece extending between said structure, said outermost one of said panels, and said trough wherein each said end piece covers a respective end opening between said panels and said structure when said panels are in said closed position; and
a flap coupled to said structure, said flap extending over said upper edge of said panel.
